(19) United States
(12) Patent Application Publication
(10) Pub. No.: US 2026/0326717 A1
(43) Pub. Date: Oct. 22, 2026

(54) ENERGY-EFFICIENT ANTI-THEFT DEVICE FOR TRAILERS

(71) Applicant: BIGWELD LLC, Tucson, AZ (US)

(72) Inventors: Richard Luhr, Tucson, AZ (US); Gonzalo Perez Dalannays, Concon (CL)

(21) Appl. No.: 19/468,117

(22) Filed: Feb. 3, 2026

Related U.S. Application Data
(60) Provisional application No. 63/790,916, filed on Apr. 18, 2025.

(51) Int. Cl. B60R 25/32; B60R 25/08; B60R 25/40

(52) U.S. Cl. CPC B60R 25/32; B60R 25/08; B60R 25/40

(57) ABSTRACT

A theft-prevention device for use in a trailer system. The device includes a motion sensing component operatively coupled to an electric braking system of the trailer system. The device may be configured to detect current motion data, filter the current motion data for noise, compare the filtered current motion data to a motion threshold, actuate, if the current motion data exceeds a motion threshold, the electric braking system of the trailer system, and deactuate, if the current motion data does not exceed the motion threshold, the electric braking system of the trailer system.

### CROSS-REFERENCE TO RELATED APPLICATIONS

This application is a non-provisional and claims benefit of U.S. Provisional Application No. 63/790,916 filed Apr. 18, 2025, the specification of which is incorporated herein in its entirety by reference.

### FIELD OF THE INVENTION

The present invention is directed to low-power motion detection and brake actuation devices to provide anti-theft capabilities to a trailer system.

### BACKGROUND OF THE INVENTION

Unlike vehicles, there are few safeguards set in place in trailer systems to prevent theft. Because of this, if given proper access, thieves can simply attach the trailer system to their own vehicle and pull it away. Motion detectors are a useful solution for determining if an unapproved party is moving the trailer, but detecting motion alone is insufficient, as it would only provide an alarm but not prevent movement. A mechanical device for detecting motion attached to the axles or brakes, like a speedometer cable on a car, is not part of the design of standard trailer axles. Even if it were, there would still be a need for some sort of electronic control module to activate the electric trailer brakes, so a mechanical solution is insufficient. This means there are several technical problems.

False positives: There are several sources of normal motion in trailers, such as people walking inside the trailer, loading equipment, raising or lowering the tongue jack, wind gusts, hitching to a tow vehicle, etc. These must be filtered out to avoid false positives.

Preservation of battery power: On-board battery power is very limited on trailers, and trailers are often left in storage for weeks or months at a time without the benefit of an electrical outlet to maintain the battery. This makes it important that a motion detection device have very low standby power requirements, and activate the brakes only as long as needed.

Installation difficulty: A motion detection device will be installed by end users (trailer owners) and OEMs (manufacturers) on a wide variety of trailers and locations. Some locations will be very restricted in terms of space, so the device should be designed to be small, easy to wire, and installable in any orientation and any location on the trailer.

Hardening the device against attacks: Mounting a security device on the outside of a trailer allows it to be defeated easily in a brute force attack, such as cutting the wires. Therefore, it would be useful for the device to be located inside the trailer so that an attacker would have to first break into the trailer in order to get to it.

Missed positives: Some travel trailers have soft suspensions. It is possible that an extremely gentle towing motion on smooth pavement might be below the detection threshold.

Unintended activation: An unintended brake actuation while towing could be dangerous. The motion detection device should be configured to prevent this.

Anti-theft solutions exist, using GPS/cellular trackers. These detect motion only after the trailer has moved a significant distance (typically ½ mile or more, depending on how the “geofence” has been defined). These solutions have numerous weak spots. They are subject to false alarms if the geofence is too narrowly defined due to errors in the GPS calculations. They only alert after the trailer has been stolen; alert delays often run 30-40 minutes. The tracker usually has to be installed on the exterior of the trailer, meaning that it can be easily found and removed. GPS trackers have high power requirements, so they are limited to checking their location infrequently. When the battery dies (in 1-2 years), the customer's options are poor: either replace the battery at a typical cost of ~$40 or replace the entire unit. They require subscriptions to maintain cellular service, typically ~$100 per year. Furthermore, these solutions do not physically stop someone from taking the trailer.

Anti-theft solutions exist that activate electric brakes when a theft attempt is detected. These prior systems use a gyroscopic sensor to detect motion and trigger an audible alarm and flashing lights at the same time. However, these solutions still face a multitude of technical challenges. Particularly, these prior systems draw 70 milliamps while activated, enough to drain a typical Group 27 lead-acid battery in a matter of 4-5 weeks. This means the trailer owner must keep the trailer plugged in during long-term storage, which is often not a practical option. These prior systems also leave the brakes activated for 30 seconds after it thinks motion has stopped, which greatly increases onboard battery consumption. If the battery(s) were to go dead, the device would cease working, and the trailer could be easily stolen. Furthermore, the installation of these systems requires up to 14 wires and takes several hours.

These prior systems can only be installed vertically at the front or rear of the trailer (away from the axles) with a large wiring harness protruding from the bottom of the unit. This limits installation locations considerably and makes concealment difficult. It also requires professional installation. Cutting the power will disable these prior systems, and there is no practical option for a backup battery. Other solutions involve sensors that detect motion inside the trailer or forced opening of the door. These are designed to prevent break-in but don't help when the thief is primarily interested in taking the entire trailer. None can activate electric brakes.

Non-powered prior systems exist for anti-theft measures for trailers. However, these amount primarily to locking mechanisms that block the trailer's hitch coupler, or which immobilize the wheels. These mechanisms, however, are highly visible and can be easily removed or bypassed without removal. Overall, this does nothing to prevent a thief from stealing a vehicle and pulling the trailer along. Thus, there exists a present need for an energy-efficient motion-detecting anti-theft measure for trailer systems able to overcome these technical challenges.

### BRIEF SUMMARY OF THE INVENTION

It is an objective of the present invention to provide devices and systems that allow for low-power motion detection and brake actuation devices to provide anti-theft capabilities to a trailer system, as specified in the independent claims. Embodiments of the invention are given in the dependent claims. Embodiments of the present invention can be freely combined with each other if they are not mutually exclusive.

The present invention features a low-power MEMS accelerometer/gyroscope to measure motion in 3 axes and an algorithm to differentiate between towing motion and other sources of movement. A microprocessor first uses the MEMS sensor data to determine the direction of gravity (the device's orientation), using a sum of squares to estimate the gravity vector direction in XYZ coordinates. The Y component (“forward” direction) is subtracted from the sensor data to remove the offset due to gravity. The microprocessor then keeps a history of samples from the MEMS device, and the compensated acceleration is converted to distance with physics equations.

Since sensor data is noisy, the estimates are cleared every second to avoid cumulative errors (“drift”). Finally, a low-pass filter removes noise, and the resulting data is compared to preset limits of time and magnitude. Data within the criteria are considered “motion” and trigger the braking relay. The present invention continues to evaluate samples to determine when motion has stopped. The energy-efficient design of the present invention requires only 8 milliamps in “armed” mode. This is sustained by a single Group 27 lead-acid battery for up to a year. The present invention may be able to be installed within about 10 minutes and only requires the connection of 3 wires. In sum, the compact and integrated design means that the present invention can accomplish its mission. It is designed to be easy to install, consume very little power, work in any orientation, be easily concealed because of its small size, and activate electric trailer brakes or other secondary devices with high reliability.

One of the unique and inventive technical features of the present invention is the implementation of a low-power accurate motion detection device powered by the battery of the trailer system, along with a charging circuit for charging an external battery such that the device autonomously swaps between power sources. Without wishing to limit the invention to any theory or mechanism, it is believed that the technical feature of the present invention advantageously provides for a low-power, reactive, and accurate system for detecting motion and preventing theft of a trailer. None of the presently known prior references or works have the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1A shows a schematic diagram of a theft-prevention device of the present invention.

FIG. 1B shows a schematic diagram of an alternate embodiment of the theft-prevention device of the present invention.

FIG. 2A shows a schematic diagram of a theft-prevention system of the present invention.

FIG. 2B shows a schematic diagram of an alternate embodiment of the theft-prevention system of the present invention.

FIG. 3A shows a flow chart diagram of a computer-implemented process for theft prevention of the present invention.

FIG. 3B shows a flow chart diagram of an alternate embodiment of the computer-implemented process for theft prevention of the present invention.

FIG. 4 shows an exploded view of the theft-prevention device of the present invention, showing the housing and internal computing components.

FIG. 5A shows an isometric view of the remote control button of the theft-prevention device of the present invention.

FIG. 5B shows an exploded view of the remote control button of the theft-prevention device of the present invention.

### DETAILED DESCRIPTION OF THE INVENTION

Following is a list of elements corresponding to a particular element referred to herein:
100 theft-prevention device
110 motion sensing component
112 accelerometer
114 gyroscope
120 microcontroller unit
122 processor
124 memory component
130 charging circuit
140 external switch
200 external battery
300 trailer system
310 electric braking system
320 battery
1000 system

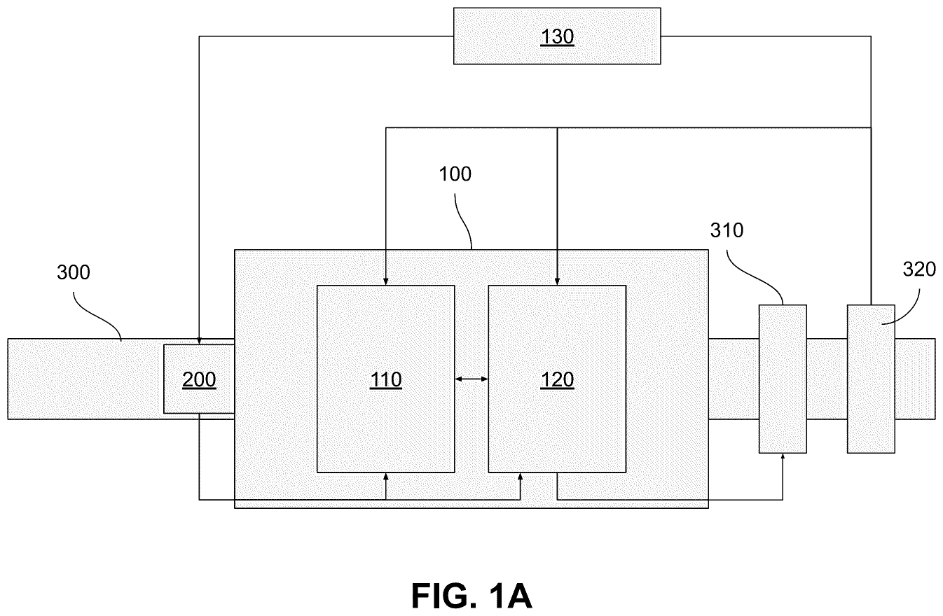

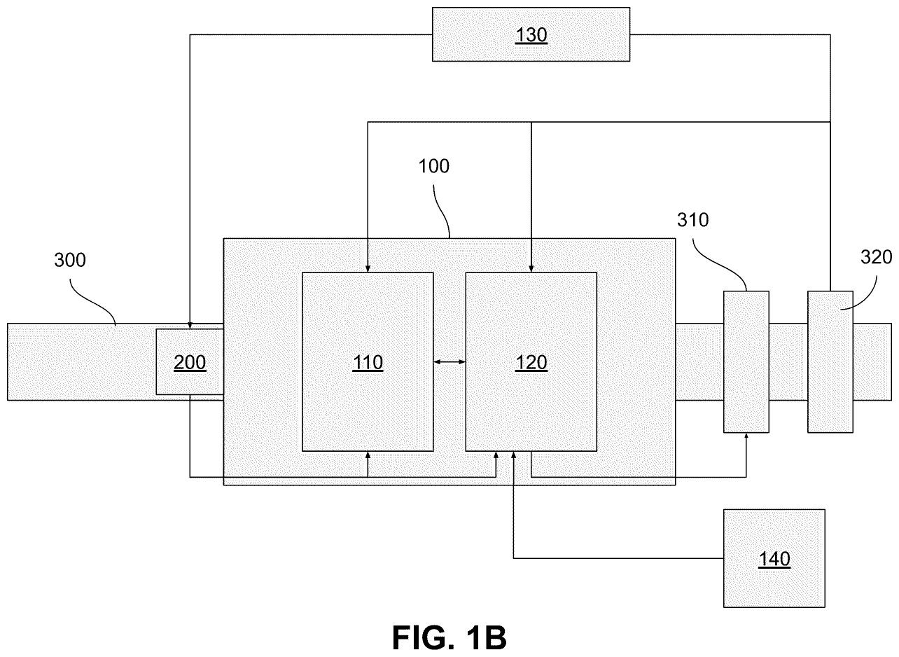

Referring now to FIG. 1A, the present invention features a theft-prevention device (100) for use in a trailer system (300). The device (100) may comprise a motion sensing component (110) operatively coupled to an electric braking system (310) of the trailer system (300), powered by a battery (320) of the trailer system (300) or an external battery (200), configured to detect current motion data. The device (100) may further comprise a microcontroller unit (120) operatively coupled to the motion sensing component (110), powered by the battery (320) of the trailer system (300) or the external battery (200), configured to arm the motion sensing component (110) to detect the current motion data, filter the current motion data for noise, compare the filtered current motion data to a motion threshold, actuate, if the current motion data exceeds a motion threshold, the electric braking system (310) of the trailer system (300), deactuate, if the current motion data does not exceed the motion threshold, the electric braking system (310) of the trailer system (300), and disarm the motion sensing component (110) to cease detecting the current motion data. The device may further comprise a charging circuit (130) operatively coupled to the battery (320) of the trailer system (300) and the external battery (200), configured to receive power from the battery (320) of the trailer system (300) to continuously charge the external battery (200).

The device (100) may be configured to swap between utilizing the battery (320) of the trailer system (300) and the external battery (200) as a power source depending on a comparison of a voltage of the battery (320) of the trailer system (300) to a voltage of the external battery (200). In some embodiments, the device (100) may utilize power from the trailer battery (320) as a default, and may swap to drawing power from the external battery (200) if power is absent in the trailer battery (320). In some embodiments, the device (100) may be configured to assess the voltage of the trailer battery (320) and the external battery (200) and draw power from whichever source has the higher voltage.

In some embodiments, the motion sensing component (110) may comprise an accelerometer (112) configured to measure linear motion data. In some embodiments, the accelerometer (112) may comprise 3 axes of directional measurement capabilities. In some embodiments, the motion sensing component (110) may comprise a gyroscope (114) configured to measure rotational motion data. In some embodiments, the motion sensing component (110) may be further configured to determine, based on the current motion data, an orientation of the motion sensing component (110). In some embodiments, the motion sensing component (110) may be further configured to adjust the current motion data for a gravity offset based on the orientation of the motion sensing component (110). In some embodiments, the gravity offset may be determined based on a sum of squares calculation executed on the current motion data. In some embodiments, the motion sensing component (110) may be further configured to filter, by a low-pass filter component, noise from the current motion data. In some embodiments, the device (100) may further comprise an external switch (140) operatively coupled to the microcontroller unit (120), the external switch (140) comprising an interface button configured to actuate, when pressed, the microcontroller unit (120) to arm the motion sensing component (110), and actuate, when pressed, the microcontroller unit (120) to disarm the motion sensing component (110) (see FIG. 1B).

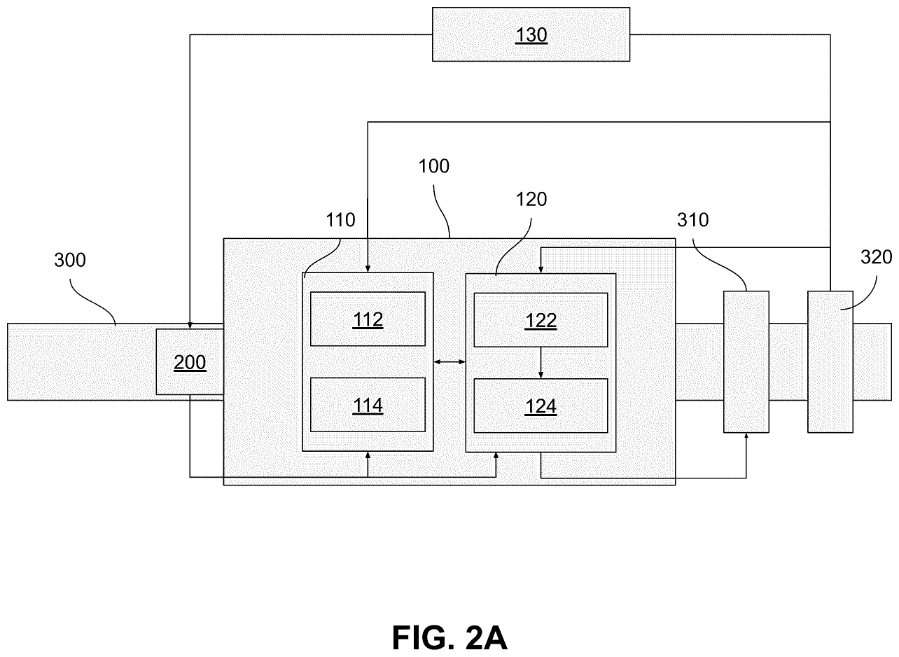

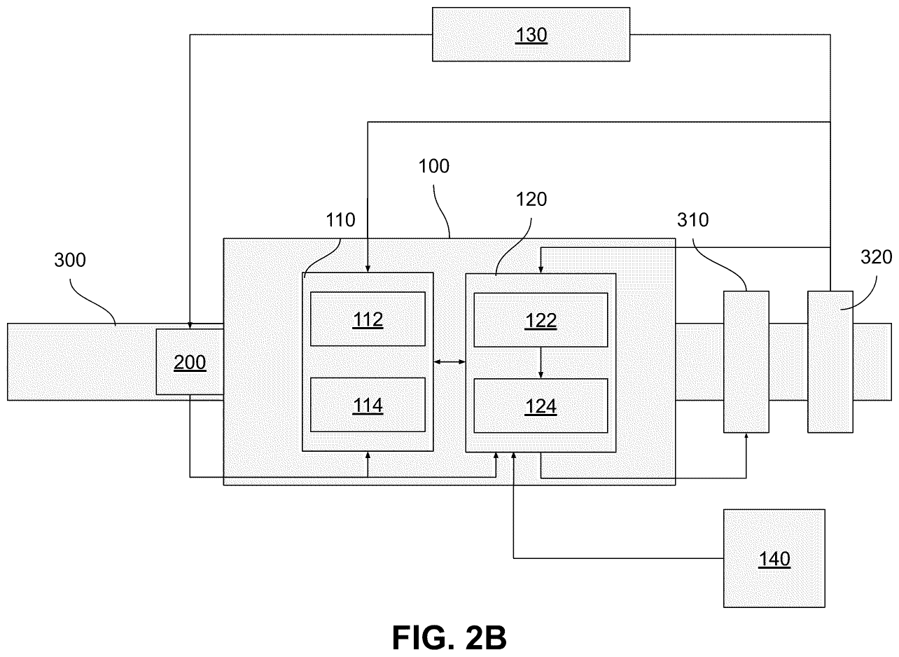

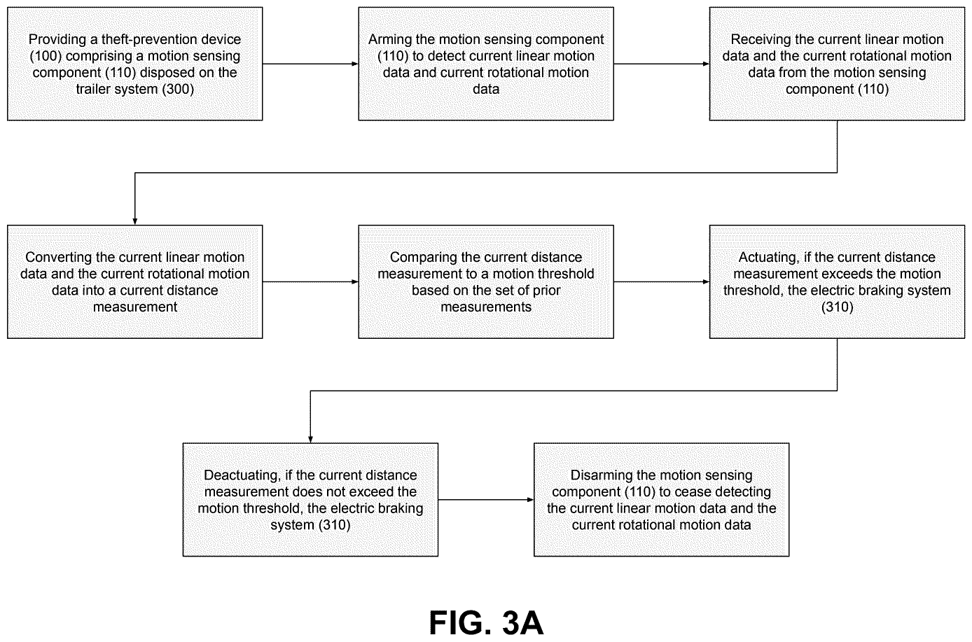

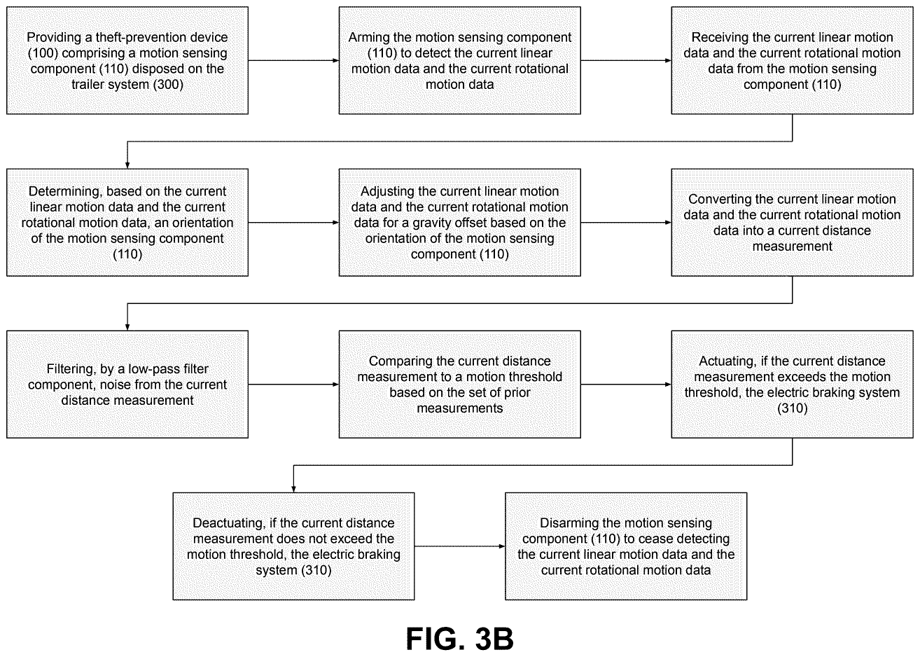

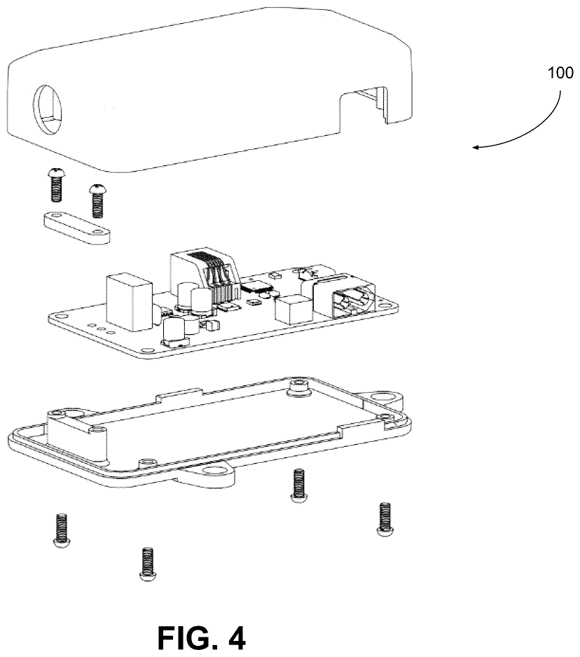

Referring now to FIG. 2A, the present invention features a theft-prevention device (100) for use in a trailer system (300). The device (100) may comprise a motion sensing component (110) disposed on the trailer system (300), powered by a battery (320) of the trailer system (300) or an external battery (200), communicatively coupled to an electric braking system (310) of the trailer system (300), comprising an accelerometer (112) configured to measure linear motion data comprising current linear motion data and a gyroscope (114) configured to measure rotational motion data comprising current rotational motion data. The device (100) may further comprise a microcontroller unit (120) communicatively coupled to the motion sensing component (110), powered by the battery (320) of the trailer system (300) or the external battery (200), comprising a processor (122) configured to execute computer-readable instructions, and a memory component (124). The memory component (124) may comprise a set of prior measurements of linear motion data and rotational motion data, and computer-readable instructions.

The computer-readable instructions may comprise arming the motion sensing component (110) to detect the current linear motion data and the current rotational motion data, receiving the current linear motion data and the current rotational motion data from the motion sensing component (110), converting the current linear motion data and the current rotational motion data into a current distance measurement, comparing the current distance measurement to a motion threshold based on the set of prior measurements, actuating, if the current distance measurement exceeds the motion threshold, the electric braking system (310), deactuating, if the current distance measurement does not exceed the motion threshold, the electric braking system (310), and disarming the motion sensing component (110) to cease detecting the current linear motion data and the current rotational motion data. The device (100) may further comprise a charging circuit (130) operatively coupled to the battery (320) of the trailer system (300) and the external battery (200), configured to receive power from the battery (320) of the trailer system (300) to continuously charge the external battery (200).

The device (100) may be configured to swap between utilizing the battery (320) of the trailer system (300) and the external battery (200) as a power source depending on a comparison of a voltage of the battery (320) of the trailer system (300) to a voltage of the external battery (200). In some embodiments, the device (100) may utilize power from the trailer battery (320) as a default, and may swap to drawing power from the external battery (200) if power is absent in the trailer battery (320). In some embodiments, the device (100) may be configured to assess the voltage of the trailer battery (320) and the external battery (200) and draw power from whichever source has the higher voltage.

In some embodiments, the computer-readable instructions may further comprise determining, based on the current linear motion data and the current rotational motion data, an orientation of the motion sensing component (110). In some embodiments, the computer-readable instructions may further comprise adjusting the current linear motion data and the current rotational motion data for a gravity offset based on the orientation of the motion sensing component (110). In some embodiments, the gravity offset may be determined based on a sum of squares calculation executed on the current linear motion data and the current rotational motion data. In some embodiments, the computer-readable instructions may further comprise filtering, by a low-pass filter component, noise from the current distance measurement. In some embodiments, the computer-readable instructions may further comprise adding the current linear motion data and the current rotational motion data to the set of prior measurements. In some embodiments, the device (100) may further comprise an external switch (140) operatively coupled to the microcontroller unit (120), the external switch (140) comprising an interface button configured to actuate, when pressed, the microcontroller unit (120) to arm the motion sensing component (110), and actuate, when pressed, the microcontroller unit (120) to disarm the motion sensing component (110) (see FIG. 2B). In some embodiments, the accelerometer (112) may comprise 3 axes of directional measurement capabilities.

The present invention features a theft-prevention device (100) for use in a trailer system (300). In some embodiments, the device (100) may comprise a motion sensing component (110) disposed on the trailer system (300) powered by a battery (320) of the trailer system (300) or an external battery (200), communicatively coupled to an electric braking system (310) of the trailer system (300), comprising an accelerometer (112) configured to measure linear motion data comprising current linear motion data and a gyroscope (114) configured to measure rotational motion data comprising current rotational motion data. The device (100) may further comprise a microcontroller unit (120) communicatively coupled to the motion sensing component (110), powered by the battery (320) of the trailer system (300) or the external battery (200), comprising a processor (122) configured to execute computer-readable instructions, and a memory component (124). The memory component (124) may comprise a set of prior measurements of linear motion data and rotational motion data, and computer-readable instructions.

The computer-readable instructions may comprise arming the motion sensing component (110) to detect the current linear motion data and the current rotational motion data, receiving the current linear motion data and the current rotational motion data from the motion sensing component (110), determining, based on the current linear motion data and the current rotational motion data, an orientation of the motion sensing component (110), adjusting the current linear motion data and the current rotational motion data for a gravity offset based on the orientation of the motion sensing component (110), converting the current linear motion data and the current rotational motion data into a current distance measurement, filtering, by a low-pass filter component, noise from the current distance measurement, comparing the current distance measurement to a motion threshold based on the set of prior measurements, actuating, if the current distance measurement exceeds the motion threshold, the electric braking system (310), deactuating, if the current distance measurement does not exceed the motion threshold, the electric braking system (310), disarming the motion sensing component (110) to cease detecting the current linear motion data and the current rotational motion data. The device (100) may further comprise a charging circuit (130) operatively coupled to the battery (320) of the trailer system (300) and the external battery (200), configured to receive power from the battery (320) of the trailer system (300) to continuously charge the external battery (200).

The device (100) may be configured to swap between utilizing the battery (320) of the trailer system (300) and the external battery (200) as a power source depending on a comparison of a voltage of the battery (320) of the trailer system (300) to a voltage of the external battery (200). In some embodiments, the device (100) may utilize power from the trailer battery (320) as a default, and may swap to drawing power from the external battery (200) if power is absent in the trailer battery (320). In some embodiments, the device (100) may be configured to assess the voltage of the trailer battery (320) and the external battery (200) and draw power from whichever source has the higher voltage.

In some embodiments, the accelerometer (112) may comprise 3 axes of directional measurement capabilities. In some embodiments, the gravity offset may be determined based on a sum of squares calculation executed on the current linear motion data and the current rotational motion data. In some embodiments, the computer-readable instructions may further comprise adding the current linear motion data and the current rotational motion data to the set of prior measurements. In some embodiments, the device (100) may further comprise an external switch (140) operatively coupled to the microcontroller unit (120), the external switch (140) comprising an interface button configured to actuate, when pressed, the microcontroller unit (120) to arm the motion sensing component (110), and actuate, when pressed, the microcontroller unit (120) to disarm the motion sensing component (110).

The present invention features a theft-prevention device (100) for use in a trailer system (300). The device (100) may comprise a motion sensing component (110) operatively coupled to an electric braking system (310) of the trailer system (300). The device (100) may be powered by a battery (320) of the trailer system (300), an external battery (200), or a combination thereof. The device (100) may be configured to detect current motion data, filter the current motion data for noise, compare the filtered current motion data to a motion threshold, actuate, if the current motion data exceeds a motion threshold, the electric braking system (310) of the trailer system (300), and deactuate, if the current motion data does not exceed the motion threshold, the electric braking system (310) of the trailer system (300).

In some embodiments, the motion sensing component (110) may comprise an accelerometer (112) configured to measure linear motion data comprising current linear motion data. In some embodiments, the accelerometer (112) may comprise 3 axes of directional measurement capabilities. In some embodiments, the motion sensing component (110) may comprise a gyroscope (114) configured to measure rotational motion data comprising current rotational motion data. In some embodiments, the motion sensing component (110) may be further configured to determine, based on the current motion data, an orientation of the motion sensing component (110). In some embodiments, the motion sensing component (110) may be further configured to adjust the current motion data for a gravity offset based on the orientation of the motion sensing component (110). In some embodiments, the gravity offset may be determined based on a sum of squares calculation executed on the current motion data. In some embodiments, the motion sensing component (110) may be further configured to filter, by a low-pass filter component, noise from the current motion data.

The present invention features a theft-prevention device (100) for use in a trailer system (300). In some embodiments, the device (100) may comprise a motion sensing component (110) disposed on the trailer system (300), powered by a battery (320) of the trailer system (300), an external battery (200), or a combination thereof, communicatively coupled to an electric braking system (310) of the trailer system (300). The motion sensing component (100) may comprise an accelerometer (112) configured to measure linear motion data comprising current linear motion data and a gyroscope (114) configured to measure rotational motion data comprising current rotational motion data.

The device (100) may further comprise a microcontroller unit (120) communicatively coupled to the motion sensing component (110), powered by a battery (320) of the trailer system (300), an external battery (200), or a combination thereof, comprising a processor (122) configured to execute computer-readable instructions, and a memory component (124). The memory component (124) may comprise a set of prior measurements of linear motion data and rotational motion data. The memory component (124) may further comprise computer-readable instructions. The computer-readable instructions may comprise receiving the current linear motion data and the current rotational motion data from the motion sensing component (110), converting the current linear motion data and the current rotational motion data into a current distance measurement, comparing the current distance measurement to a motion threshold based on the set of prior measurements, actuating, if the current distance measurement exceeds the motion threshold, the electric braking system (310), and deactuating, if the current distance measurement does not exceed the motion threshold, the electric braking system (310).

In some embodiments, the computer-readable instructions may further comprise determining, based on the current linear motion data and the current rotational motion data, an orientation of the motion sensing component (110). In some embodiments, the computer-readable instructions may further comprise adjusting the current linear motion data and the current rotational motion data for a gravity offset based on the orientation of the motion sensing component (110). In some embodiments, the gravity offset may be determined based on a sum of squares calculation executed on the current linear motion data and the current rotational motion data. In some embodiments, the computer-readable instructions may further comprise filtering, by a low-pass filter component, noise from the current distance measurement. In some embodiments, the computer-readable instructions may further comprise adding the current linear motion data and the current rotational motion data to the set of prior measurements. In some embodiments, the accelerometer (112) may comprise 3 axes of directional measurement capabilities.

The motion sensing component (110) may comprise a microelectromechanical system (MEMS) configured to measure acceleration in the X, Y, and Z axes. Because the invention may be oriented in any direction, the sum of the squares of the three axes is compared to the individual values of X, Y, and Z, to determine the direction of gravity and calculate an offset. The invention continuously monitors the motion data. The offset is subtracted from the sum sensor data to remove the effect of gravity. This allows the invention to accurately determine acceleration in any direction. Motion is determined by comparing recent data history, and converted to distance using standard Physics equations. The standard Physics equations may comprise v=u+at, where final velocity (v) of an object equals initial velocity (u) of that object plus acceleration (a) of the object (sampled every 10 ms) times the elapsed time (t) from u to v. The equations may further comprise d=vt. where distance (d) is computed as the sum of velocities (v) at the same 10 ms intervals (t). Once a prescribed distance is measured, the device may activate. The sensor data is subject to drift, so the invention recalculates the gravity vector and offset every second. In addition to keeping the device accurate, this allows it to accurately determine motion even when its orientation is changed.

The present invention features a theft-prevention device (100) for use in a trailer system (300). The device (100) may comprise a motion sensing component (110) disposed on the trailer system (300), powered by a battery (320) of the trailer system (300), an external battery (200), or a combination thereof, communicatively coupled to an electric braking system (310) of the trailer system (300). The motion sensing component (110) may comprise an accelerometer (112) configured to measure linear motion data comprising current linear motion data and a gyroscope (114) configured to measure rotational motion data comprising current rotational motion data.

The device (100) may further comprise a microcontroller unit (120) communicatively coupled to the motion sensing component (110), powered by a battery (320) of the trailer system (300), an external battery (200), or a combination thereof, comprising a processor (122) configured to execute computer-readable instructions, and a memory component (124). The memory component (124) may comprise a set of prior measurements of linear motion data and rotational motion data. The memory component (124) may further comprise computer-readable instructions. The computer-readable instructions may comprise receiving the current linear motion data and the current rotational motion data from the motion sensing component (110), determining, based on the current linear motion data and the current rotational motion data, an orientation of the motion sensing component (110), adjusting the current linear motion data and the current rotational motion data for a gravity offset based on the orientation of the motion sensing component (110), converting the current linear motion data and the current rotational motion data into a current distance measurement, filtering, by a low-pass filter component, noise from the current distance measurement, comparing the current distance measurement to a motion threshold based on the set of prior measurements, actuating, if the current distance measurement exceeds the motion threshold, the electric braking system (310), and deactuating, if the current distance measurement does not exceed the motion threshold, the electric braking system (310).

In some embodiments, the accelerometer (112) may comprise 3 axes of directional measurement capabilities. In some embodiments, the gravity offset may be determined based on a sum of squares calculation executed on the current linear motion data and the current rotational motion data. In some embodiments, the computer-readable instructions may further comprise adding the current linear motion data and the current rotational motion data to the set of prior measurements.

The present invention features a system (1000) for trailer theft prevention. In some embodiments, the system (1000) may comprise a trailer system (300) comprising a battery (320) and an electric braking system (310). The system (1000) may further comprise a theft-prevention device (100) disposed on the trailer system (300), comprising a motion sensing component (110) operatively coupled to the electric braking system (310), powered by the battery (320). The motion sensing component (110) may be configured to detect current motion data, filter the current motion data for noise, compare the filtered current motion data to a motion threshold, actuate, if the current motion data exceeds a motion threshold, the electric braking system (310), and deactuate, if the current motion data does not exceed the motion threshold, the electric braking system (310).

In some embodiments, the motion sensing component (110) may comprise an accelerometer (112) configured to measure linear motion data comprising current linear motion data. In some embodiments, the accelerometer (112) may comprise 3 axes of directional measurement capabilities. In some embodiments, the motion sensing component (110) may comprise a gyroscope (114) configured to measure rotational motion data comprising current rotational motion data. In some embodiments, the motion sensing component (110) may be further configured to determine, based on the current motion data, an orientation of the motion sensing component (110). In some embodiments, the motion sensing component (110) may be further configured to adjust the current motion data for a gravity offset based on the orientation of the motion sensing component (110). In some embodiments, the gravity offset may be determined based on a sum of squares calculation executed on the current motion data. In some embodiments, the motion sensing component (110) may be further configured to filter, by a low-pass filter component, noise from the current motion data.

The present invention features a system (1000) for trailer theft prevention. In some embodiments, the system (1000) may comprise a trailer system (300) comprising a battery (320) and an electric braking system (310). The system (1000) may further comprise a theft-prevention device (100) disposed on the trailer system (300). The device (100) may comprise a motion sensing component (110) disposed on the trailer system (300), powered by the battery (320), communicatively coupled to the electric braking system (310). The motion sensing component (110) may comprise an accelerometer (112) configured to measure linear motion data comprising current linear motion data and a gyroscope (114) configured to measure rotational motion data comprising current rotational motion data.

The device (100) may further comprise a microcontroller unit (120) communicatively coupled to the motion sensing component (110), powered by a battery (320) of the trailer system (300), an external battery (200), or a combination thereof, comprising a processor (122) configured to execute computer-readable instructions, and a memory component (124). The memory component (124) may comprise a set of prior measurements of linear motion data and rotational motion data. The memory component (124) may further comprise computer-readable instructions. The computer-readable instructions may comprise receiving the current linear motion data and the current rotational motion data from the motion sensing component (110), converting the current linear motion data and the current rotational motion data into a current distance measurement, comparing the current distance measurement to a motion threshold based on the set of prior measurements, actuating, if the current distance measurement exceeds the motion threshold, the electric braking system (310), and deactuating, if the current distance measurement does not exceed the motion threshold, the electric braking system (310).

In some embodiments, the computer-readable instructions may further comprise determining, based on the current linear motion data and the current rotational motion data, an orientation of the motion sensing component (110). In some embodiments, the computer-readable instructions may further comprise adjusting the current linear motion data and the current rotational motion data for a gravity offset based on the orientation of the motion sensing component (110). In some embodiments, the gravity offset may be determined based on a sum of squares calculation executed on the current linear motion data and the current rotational motion data. In some embodiments, the computer-readable instructions may further comprise filtering, by a low-pass filter component, noise from the current distance measurement. In some embodiments, the computer-readable instructions may further comprise adding the current linear motion data and the current rotational motion data to the set of prior measurements. In some embodiments, the accelerometer (112) may comprise 3 axes of directional measurement capabilities.

The present invention features a system (1000) for trailer theft prevention. In some embodiments, the system (1000) may comprise a trailer system (300) comprising a battery (320) and an electric braking system (310). The system (1000) may further comprise a theft-prevention device (100) disposed on the trailer system (300). The device (100) may comprise a motion sensing component (110) disposed on the trailer system (300), powered by the battery (320), communicatively coupled to the electric braking system (310). The motion sensing component (110) may comprise an accelerometer (112) configured to measure linear motion data comprising current linear motion data and a gyroscope (114) configured to measure rotational motion data comprising current rotational motion data.

The device (100) may further comprise a microcontroller unit (120) communicatively coupled to the motion sensing component (110), powered by a battery (320) of the trailer system (300), an external battery (200), or a combination thereof, comprising a processor (122) configured to execute computer-readable instructions, and a memory component (124). The memory component (124) may comprise a set of prior measurements of linear motion data and rotational motion data. The memory component (124) may further comprise computer-readable instructions. The computer-readable instructions may comprise receiving the current linear motion data and the current rotational motion data from the motion sensing component (110), determining, based on the current linear motion data and the current rotational motion data, an orientation of the motion sensing component (110), adjusting the current linear motion data and the current rotational motion data for a gravity offset based on the orientation of the motion sensing component (110), converting the current linear motion data and the current rotational motion data into a current distance measurement, filtering, by a low-pass filter component, noise from the current distance measurement, comparing the current distance measurement to a motion threshold based on the set of prior measurements, actuating, if the current distance measurement exceeds the motion threshold, the electric braking system (310), and deactuating, if the current distance measurement does not exceed the motion threshold, the electric braking system (310).

In some embodiments, the accelerometer (112) may comprise 3 axes of directional measurement capabilities. In some embodiments, the gravity offset may be determined based on a sum of squares calculation executed on the current linear motion data and the current rotational motion data. In some embodiments, the computer-readable instructions may further comprise adding the current linear motion data and the current rotational motion data to the set of prior measurements.

The present invention features a method for preventing theft of a trailer system (300). In some embodiments, the method may comprise providing a theft-prevention device (100) comprising a motion sensing component (110) disposed on the trailer system (300), powered by a battery (320) of the trailer system (300), an external battery (200), or a combination thereof, communicatively coupled to an electric braking system (310) of the trailer system (300), comprising an accelerometer (112) and a gyroscope (114). The method may further comprise measuring, by the accelerometer (112), linear motion data comprising current linear motion data. The method may further comprise measuring, by the gyroscope (114), rotational motion data comprising current rotational motion data. The method may further comprise converting the current linear motion data and the current rotational motion data into a current distance measurement. The method may further comprise comparing the current distance measurement to a motion threshold based on a set of prior measurements comprising linear motion data and rotational motion data. The method may further comprise actuating, if the current distance measurement exceeds the motion threshold, the electric braking system (310). The method may further comprise deactuating, if the current distance measurement does not exceed the motion threshold, the electric braking system (310).

In some embodiments, the method may further comprise determining, based on the current linear motion data and the current rotational motion data, an orientation of the motion sensing component (110). In some embodiments, the method may further comprise adjusting the current linear motion data and the current rotational motion data for a gravity offset based on the orientation of the motion sensing component (110). In some embodiments, determining the gravity offset may comprise executing a sum of squares calculation on the current linear motion data and the current rotational motion data. In some embodiments, the method may further comprise filtering, by a low-pass filter component, noise from the current distance measurement. In some embodiments, the method may further comprise adding the current linear motion data and the current rotational motion data to the set of prior measurements.

In some embodiments, the device/system of the present invention may be powered by an external battery (200). This has three advantages: (1) it can be installed on a trailer that lacks batteries; (2) the backup battery can maintain the system even when the trailer's primary battery has been depleted. (3) The backup battery can be located in a place that is hard to reach by a thief. The present invention will work from any power source that is available, even power incidentally supplied by the tow vehicle through a typical 7-way or 4-way trailer plug.

In some embodiments, once the device of the present invention has been triggered, the brakes may remain actuated until manually disarmed by the user (e.g., through inputting a password into the device). Accordingly, the device of the present invention may comprise one or more user interface components, such as a keypad or a biometrics component. In some embodiments, the brakes may remain actuated until a certain period of time has elapsed. This period of time may be pre-installed into the device or may be set manually by the user. Upon actuation of the brakes, the device may be configured to transmit an alert to notify that the device was triggered. This alert may be in the form of a visual alert (e.g., a flashing light), an audio alert (e.g., a beep), a notification on a software application, or a combination thereof. Accordingly, the device of the present invention may be communicatively coupled to an external computing device (e.g., a smartphone, a desktop computer, etc.) configured to run a software application. The software application may be configured to receive alerts from the theft-prevention device, display properties of the device (e.g., power usage, power source), or a combination thereof.

The theft-prevention device of the present invention may implement a charging circuit for automatically maintaining an external backup battery. As stated above, the device may be primarily powered by a nominal 12-volt connection to the trailer battery. This power may also be incidentally supplied from a tow vehicle 7-way or 4-way plug, on the same wire, as noted. A backup Lithium Iron Phosphate (LiFePO4) battery may additionally be installed. If the backup battery is installed, and the voltage from the trailer battery is above a given threshold level defined in the software (e.g. 10 to 15 volts), the power from this source may be upconverted (e.g., up to 12 to 16 volts) to charge the backup battery as needed.

The device may be configured to swap between utilizing the battery of the trailer system and the external battery as a power source depending on a comparison of a voltage of the battery of the trailer system to a voltage of the external battery. The device may be configured to draw power from the highest voltage source available. In some embodiments, the device may only draw power from a source if the voltage exceeds a given threshold. For example, the trailer battery must be at or above 10 to 15 volts for the device to draw power from it, and/or the external backup battery must be at or above 10 to 15 volts for the device to draw power from it. In some embodiments, the device may only draw power from a source if the voltage is at or above a percentage threshold of the power source's maximum capacity (e.g., 50%).

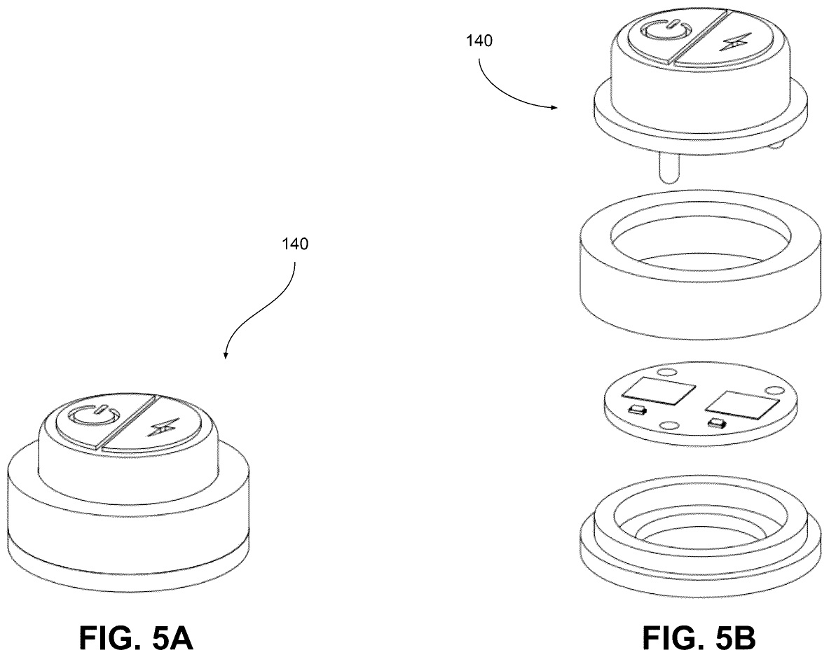

In some embodiments, the device of the present invention may further comprise an external remote switch for controlling the functionality of the device. It should be noted that all features described in the above paragraph(s) relating to functionality for the user to interact with the device itself may instead or additionally be implemented as components of the remote switch (e.g., arming and disarming). The remote switch may comprise one or more interface components configured to actuate the device (e.g., the microcontroller) to arm or disarm the motion sensing component. The interface components may comprise a switch having an armed configuration and a disarmed configuration such that the status of the motion sensing component is dependent on the configuration of the switch. The interface components may comprise a button configured to swap the status of the motion sensing component between an armed status and a disarmed status. The remote switch may further comprise one or more light-emitting diodes (LEDs) to indicate a status of the device (e.g., armed, unarmed, malfunctioning, etc.). Views of the remote switch are depicted in FIGS. 5A-5B.

In some embodiments, the device of the present invention may comprise electrical protection functionality to prevent issues, such as reversed polarity, electrostatic discharge, and short circuiting. To protect from electrostatic discharge (ESD), the primary terminal and the backup battery connector may include automotive grade (e.g., 600 W, 36V) surge protections. The remote switch port pins may comprise surge protection (e.g., 4.3V, 2,000 W) as well. To protect against reverse polarity, the main power supply (e.g., the trailer battery) may implement an integrated circuit programmed to track the current direction and block the supply of power in case the current drops below a threshold, effectively cutting off the supply before current goes backwards. The backup battery reverse detection may implement an integrated circuit with switches at both positive and negative terminals. The switches may close when the battery plug has the right polarity, or remain in open circuit until the battery is disconnected. Filtering may additionally be implemented for a smooth switch-over, preventing current transients from the trailer wiring. Both inputs may additionally implement antistatic protection (e.g., Transient-Voltage-Suppression diodes) to meet automotive standards.

### Example

The following is a non-limiting example of the present invention. It is to be understood that said example is not intended to limit the present invention in any way. Equivalents or substitutes are within the scope of the present invention.

A theft-prevention device kit includes the device module, adhesive pads and screws, a remote control button with a cable (e.g., 9 foot long cable), an arming button cover, wire splicing connectors (e.g., Wago® connectors), a backup battery cable, a warning flag, and caution stickers. For installation of the theft-prevention device, the following tools are required: a wire cutter, a wire stripper, a screwdriver (optionally), a voltmeter, a drill, and a hole saw (optionally). Installation of the theft-prevention device kit may involve the installation of an optional battery backup, which will require a lithium iron phosphate battery with a minimum 9 Ah capacity, a mounting bracket, and hardware to affix the bracket (e.g., bolts and screws).

All power sources are disconnected prior to installation. The device can be mounted at any dry, rigid point on the trailer and in any orientation, such as inside of the trailer where the wires from the 7-way/4-way plug enter the interior. The device is positioned such that the remote control button can be routed to it. The backup battery, if application, is mounted within 6 feet of the device. The wires from the 7-way/4-way plug are cut and the insulation is stripped. The stripped ends are individually slid into the wire splicing connectors along with wires from the theft-prevention device to connect the main trailer battery and the electric braking system to the device. The device is then mounted to the dry-rigid point using the adhesive pads and/or the screws. It is mounted in any orientation but must be securely attached. The remote control button is then plugged into the theft-prevention device and mounted in a convenient location (a hard flat surface where the status lights can be clearly seen and where it is unlikely to be bumped or touched by objects during towing. If a backup battery is to be installed to continue to provide power if the main trailer battery is discharged or disconnected, the backup battery is connected to the device with the backup battery cable. The backup battery is automatically charged whenever there is at least 12.1 volts applied to the wire. The backup battery takes over and powers the device whenever power from the trailer's onboard battery is not present or too low, until the voltage of the backup battery drops to 13.0 volts or less. The device is tested after installing the device but without arming it to ensure that the brakes are working normally. The device is then armed.

Once the device is installed and armed, the theft-prevention device runs off of the power of the battery of the trailer system, or the backup battery if installed and if the battery of the trailer system is unavailable. The drive detects motion data (e.g., linear motion data and rotational motion data) continuously, normalizes and filters the motion data for noise (e.g., adjusting the motion data for a gravity offset based on the orientation, filtering with a low-pass filter), compares the filtered motion data to a predetermined motion threshold, and, if the filtered motion data exceeds the threshold, actuates the brakes for the trailer. Once the filtered motion data no longer exceeds this threshold, the brakes are then disabled.

The microcontroller of the present invention may comprise a computer system. The computer system can include a desktop computer, a workstation computer, a laptop computer, a netbook computer, a tablet, a handheld computer (including a smartphone), a server, a supercomputer, a wearable computer (including a smart watch), or the like and can include digital electronic circuitry, firmware, hardware, memory, a computer storage medium, a computer program, a processor (including a programmed processor), an imaging apparatus, wired/wireless communication components, or the like.

The term “processor” encompasses all kinds of apparatus, devices, and machines for processing data, including by way of example a programmable microprocessor, a microcontroller comprising a microprocessor and a memory component, an embedded processor, a digital signal processor, a media processor, a computer, a system on a chip, or multiple ones, or combinations, of the foregoing. The apparatus can include special-purpose logic circuitry, e.g., an FPGA (field programmable gate array) or an ASIC (application-specific integrated circuit). Logic circuitry may comprise multiplexers, registers, arithmetic logic units (ALUs), computer memory, look-up tables, flip-flops (FF), wires, input blocks, output blocks, read-only memory, randomly accessible memory, electronically-erasable programmable read-only memory, flash memory, discrete gate or transistor logic, discrete hardware components, or any combination thereof. The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The processor may include one or more processors of any type, such as central processing units (CPUs), graphics processing units (GPUs), special-purpose signal or image processors, field-programmable gate arrays (FPGAs), tensor processing units (TPUs), and so forth.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, a data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or can be included in, one or more separate physical components or media (e.g., multiple CDs, drives, or other storage devices). The operations described in this specification can be implemented as operations performed by a data processing apparatus on data stored on one or more computer-readable storage devices or received from other sources.

Program code embodied on a computer readable medium may be transmitted using any appropriate medium, including but not limited to wireless, wireline, optical fiber cable, R. F, Bluetooth, storage media, computer buses, etc., or any suitable combination of the foregoing. Computer program code for carrying out operations for aspects of the present disclosure may be written in any combination of one or more programming languages, including an object oriented programming language such as Java, Smalltalk, C#, Ruby, or the like, conventional procedural programming languages, such as Pascal, FORTRAN, BASIC, or similar programming languages, programming languages that have both object-oriented and procedural aspects, such as the “C” programming language, C++, Python, or the like, conventional functional programming languages such as Scheme, Common Lisp, Elixir, or the like, conventional scripting programming languages such as PHP, Perl, Javascript, or the like, or conventional logic programming languages such as PROLOG, ASAP, Datalog, or the like.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Computers typically include known components, such as a processor, an operating system, system memory, memory storage devices, input-output controllers, input-output devices, and display devices. It will also be understood by those of ordinary skill in the relevant art that there are many possible configurations and components of a computer and may also include cache memory, a data backup unit, and many other devices. To provide for interaction with a user, embodiments of the subject matter described in this specification can be implemented on a computer having a display device, e.g., an LCD (liquid crystal display), LED (light emitting diode) display, or OLED (organic light emitting diode) display, for displaying information to the user.

An interface controller may also be included that may comprise any of a variety of known or future software programs for providing input and output interfaces. For example, interfaces may include what are generally referred to as “Graphical User Interfaces” (often referred to as GUI's) that provide one or more graphical representations to a user. Interfaces are typically enabled to accept user inputs using means of selection or input known to those of ordinary skill in the related art. In some implementations, the interface may be a touch screen that can be used to display information and receive input from a user. In the same or alternative embodiments, applications on a computer may employ an interface that includes what are referred to as “command line interfaces” (often referred to as CLI's). CLI's typically provide a text based interaction between an application and a user. Typically, command line interfaces present output and receive input as lines of text through display devices. For example, some implementations may include what are referred to as a “shell” such as Unix Shells known to those of ordinary skill in the related art, or Microsoft® Windows Powershell that employs object-oriented type programming architectures such as the Microsoft® .NET framework.

Those of ordinary skill in the related art will appreciate that interfaces may include one or more GUI's, CLI's or a combination thereof. A processor may include a commercially available processor such as a Celeron, Core, or Pentium processor made by Intel Corporation®, a SPARC processor made by Sun Microsystems®, an Athlon, Sempron, Phenom, or Opteron processor made by AMD Corporation®, or it may be one of other processors that are or will become available. Some embodiments of a processor may include what is referred to as multi-core processor and/or be enabled to employ parallel processing technology in a single or multi-core configuration. For example, a multi-core architecture typically comprises two or more processor “execution cores”. In the present example, each execution core may perform as an independent processor that enables parallel execution of multiple threads. In addition, those of ordinary skill in the related field will appreciate that a processor may be configured in what is generally referred to as 32 or 64 bit architectures, or other architectural configurations now known or that may be developed in the future.

A processor typically executes an operating system, which may be, for example, a Windows type operating system from the Microsoft Corporation®; the Mac OS X operating system from Apple Computer Corp.®; a Unix® or Linux®-type operating system available from many vendors or what is referred to as an open source; another or a future operating system; or some combination thereof. An operating system interfaces with firmware and hardware in a well-known manner, and facilitates the processor in coordinating and executing the functions of various computer programs that may be written in a variety of programming languages. An operating system, typically in cooperation with a processor, coordinates and executes functions of the other components of a computer. An operating system also provides scheduling, input-output control, file and data management, memory management, and communication control and related services, all in accordance with known techniques.

Connecting components may be properly termed as computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

### EMBODIMENTS

The following embodiments are intended to be illustrative only and not to be limiting in any way.

Embodiment 1: A system (1000) for trailer theft prevention, the system (1000) comprising: a trailer system (300) comprising a battery (320) and an electric braking system (310); a theft-prevention device (100) disposed on the trailer system (300), comprising a motion sensing component (110) operatively coupled to an electric braking system (310) of the trailer system (300), powered by a battery (320) of the trailer system (300) or an external battery (200), configured to detect current motion data; a microcontroller unit (120) operatively coupled to the motion sensing component (110), powered by the battery (320) of the trailer system (300) or the external battery (200), configured to arm the motion sensing component (110) to detect the current motion data, filter the current motion data for noise, compare the filtered current motion data to a motion threshold, actuate, if the current motion data exceeds a motion threshold, the electric braking system (310) of the trailer system (300), deactuate, if the current motion data does not exceed the motion threshold, the electric braking system (310) of the trailer system (300), and disarm the motion sensing component (110) to cease detecting the current motion data; and a charging circuit (130) operatively coupled to the battery (320) of the trailer system (300) and the external battery (200), configured to receive power from the battery (320) of the trailer system (300) to continuously charge the external battery (200).

Embodiment 2: The system (1000) of Embodiment 2, wherein the motion sensing component (110) comprises an accelerometer (112) configured to measure linear motion data comprising current linear motion data.

Embodiment 3: The system (1000) of Embodiment 2, wherein the accelerometer (112) comprises 3 axes of directional measurement capabilities.

Embodiment 4: The system (1000) of Embodiment 1, wherein the motion sensing component (110) comprises a gyroscope (114) configured to measure rotational motion data comprising current rotational motion data.

Embodiment 5: The system (1000) of Embodiment 1, wherein the motion sensing component (110) is further configured to determine, based on the current motion data, an orientation of the motion sensing component (110).

Embodiment 6: The system (1000) of Embodiment 5, wherein the motion sensing component (110) is further configured to adjust the current motion data for a gravity offset based on the orientation of the motion sensing component (110).

Embodiment 7: The system (1000) of Embodiment 6, wherein the gravity offset is determined based on a sum of squares calculation executed on the current motion data.

Embodiment 8: The system (1000) of Embodiment 1, wherein the motion sensing component (110) is further configured to filter, by a low-pass filter component, noise from the current motion data.

Embodiment 9: A system (1000) for trailer theft prevention, the system (1000) comprising: a trailer system (300) comprising a battery (320) and an electric braking system (310); and a theft-prevention device (100) disposed on the trailer system (300), the device (100) comprising: a motion sensing component (110) disposed on the trailer system (300), powered by a battery (320) of the trailer system (300) or an external battery (200), communicatively coupled to an electric braking system (310) of the trailer system (300), comprising an accelerometer (112) configured to measure linear motion data comprising current linear motion data and a gyroscope (114) configured to measure rotational motion data comprising current rotational motion data; a microcontroller unit (120) communicatively coupled to the motion sensing component (110), powered by the battery (320) of the trailer system (300) or the external battery (200), comprising a processor (122) configured to execute computer-readable instructions, and a memory component (124) comprising: a set of prior measurements of linear motion data and rotational motion data; computer-readable instructions for: arming the motion sensing component (110) to detect the current linear motion data and the current rotational motion data; receiving the current linear motion data and the current rotational motion data from the motion sensing component (110); converting the current linear motion data and the current rotational motion data into a current distance measurement; comparing the current distance measurement to a motion threshold based on the set of prior measurements; actuating, if the current distance measurement exceeds the motion threshold, the electric braking system (310); deactuating, if the current distance measurement does not exceed the motion threshold, the electric braking system (310); and disarming the motion sensing component (110) to cease detecting the current linear motion data and the current rotational motion data; and a charging circuit (130) operatively coupled to the battery (320) of the trailer system (300) and the external battery (200), configured to receive power from the battery (320) of the trailer system (300) to continuously charge the external battery (200).

Embodiment 10: The system (1000) of Embodiment 9, wherein the computer-readable instructions further comprise determining, based on the current linear motion data and the current rotational motion data, an orientation of the motion sensing component (110).

Embodiment 11: The system (1000) of Embodiment 10, wherein the computer-readable instructions further comprise adjusting the current linear motion data and the current rotational motion data for a gravity offset based on the orientation of the motion sensing component (110).

Embodiment 12: The system (1000) of Embodiment 11, wherein the gravity offset is determined based on a sum of squares calculation executed on the current linear motion data and the current rotational motion data.

Embodiment 13: The system (1000) of Embodiment 9, wherein the computer-readable instructions further comprise filtering, by a low-pass filter component, noise from the current distance measurement.

Embodiment 14: The system (1000) of Embodiment 9, wherein the computer-readable instructions further comprise adding the current linear motion data and the current rotational motion data to the set of prior measurements.

Embodiment 15: The system (1000) of Embodiment 9, wherein the accelerometer (112) comprises 3 axes of directional measurement capabilities.

Embodiment 16: A system (1000) for trailer theft prevention, the system (1000) comprising: a trailer system (300) comprising a battery (320) and an electric braking system (310); and a theft-prevention device (100) disposed on the trailer system (300), the device (100) comprising: a motion sensing component (110) disposed on the trailer system (300) powered by a battery (320) of the trailer system (300) or an external battery (200), communicatively coupled to an electric braking system (310) of the trailer system (300), comprising an accelerometer (112) configured to measure linear motion data comprising current linear motion data and a gyroscope (114) configured to measure rotational motion data comprising current rotational motion data; and a microcontroller unit (120) communicatively coupled to the motion sensing component (110), powered by the battery (320) of the trailer system (300) or the external battery (200), comprising a processor (122) configured to execute computer-readable instructions, and a memory component (124) comprising: a set of prior measurements of linear motion data and rotational motion data; computer-readable instructions for: arming the motion sensing component (110) to detect the current linear motion data and the current rotational motion data; receiving the current linear motion data and the current rotational motion data from the motion sensing component (110); determining, based on the current linear motion data and the current rotational motion data, an orientation of the motion sensing component (110); adjusting the current linear motion data and the current rotational motion data for a gravity offset based on the orientation of the motion sensing component (110); converting the current linear motion data and the current rotational motion data into a current distance measurement; filtering, by a low-pass filter component, noise from the current distance measurement; comparing the current distance measurement to a motion threshold based on the set of prior measurements; actuating, if the current distance measurement exceeds the motion threshold, the electric braking system (310); deactuating, if the current distance measurement does not exceed the motion threshold, the electric braking system (310); and disarming the motion sensing component (110) to cease detecting the current linear motion data and the current rotational motion data; and a charging circuit (130) operatively coupled to the battery (320) of the trailer system (300) and the external battery (200), configured to receive power from the battery (320) of the trailer system (300) to continuously charge the external battery (200).

Embodiment 17: The system (1000) of Embodiment 16, wherein the accelerometer (112) comprises 3 axes of directional measurement capabilities.

Embodiment 18: The system (1000) of Embodiment 16, wherein the gravity offset is determined based on a sum of squares calculation executed on the current linear motion data and the current rotational motion data.

Embodiment 19: The system (1000) of Embodiment 16, wherein the computer-readable instructions further comprise adding the current linear motion data and the current rotational motion data to the set of prior measurements.

Embodiment 20: A method for preventing theft of a trailer system (300), the method comprising: providing a theft-prevention device (100) comprising a motion sensing component (110) disposed on the trailer system (300), powered by a battery (320) of the trailer system (300), an external battery (200), or a combination thereof, communicatively coupled to an electric braking system (310) of the trailer system (300), comprising an accelerometer (112) and a gyroscope (114); arming the motion sensing component (110) to detect current linear motion data and current rotational motion data; measuring, by the accelerometer (112), linear motion data comprising the current linear motion data; measuring, by the gyroscope (114), rotational motion data comprising the current rotational motion data; converting the current linear motion data and the current rotational motion data into a current distance measurement; comparing the current distance measurement to a motion threshold based on a set of prior measurements comprising linear motion data and rotational motion data; actuating, if the current distance measurement exceeds the motion threshold, the electric braking system (310); deactuating, if the current distance measurement does not exceed the motion threshold, the electric braking system (310); and disarming the motion sensing component (110) to cease detecting the current linear motion data and the current rotational motion data.

Embodiment 21: The method of Embodiment 20 further comprising determining, based on the current linear motion data and the current rotational motion data, an orientation of the motion sensing component (110).

Embodiment 22: The method of Embodiment 21 further comprising adjusting the current linear motion data and the current rotational motion data for a gravity offset based on the orientation of the motion sensing component (110).

Embodiment 23: The method of Embodiment 22, wherein determining the gravity offset comprises executing a sum of squares calculation on the current linear motion data and the current rotational motion data.

Embodiment 24: The method of Embodiment 20 further comprising filtering, by a low-pass filter component, noise from the current distance measurement.

Embodiment 25: The method of Embodiment 20 further comprising adding the current linear motion data and the current rotational motion data to the set of prior measurements.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

Reference numbers recited herein, in the drawings, and in the claims are solely for ease of examination of this patent application and are exemplary. The reference numbers are not intended in any way to limit the scope of the claims to the particular features having the corresponding reference numbers in the drawings.

What is claimed is:

1) A theft-prevention device (100) for use in a trailer system (300), the device (100) comprising:
a) a motion sensing component (110) operatively coupled to an electric braking system (310) of the trailer system (300), powered by a battery (320) of the trailer system (300) or an external battery (200), configured to detect current motion data;
b) a microcontroller unit (120) operatively coupled to the motion sensing component (110), powered by the battery (320) of the trailer system (300) or the external battery (200), configured to arm the motion sensing component (110) to detect the current motion data, filter the current motion data for noise, compare the filtered current motion data to a motion threshold, actuate, if the current motion data exceeds a motion threshold, the electric braking system (310) of the trailer system (300), deactuate, if the current motion data does not exceed the motion threshold, the electric braking system (310) of the trailer system (300), and disarm the motion sensing component (110) to cease detecting the current motion data; and
c) a charging circuit (130) operatively coupled to the battery (320) of the trailer system (300) and the external battery (200), configured to receive power from the battery (320) of the trailer system (300) to continuously charge the external battery (200), wherein the device (100) is configured to swap between utilizing the battery (320) of the trailer system (300) and the external battery (200) as a power source depending on a comparison of a voltage of the battery (320) of the trailer system (300) to a voltage of the external battery (200).

2) The device (100) of claim 1, wherein the motion sensing component (110) comprises an accelerometer (112) configured to measure linear motion data.

3) The device (100) of claim 2, wherein the accelerometer (112) comprises 3 axes of directional measurement capabilities.

4) The device (100) of claim 1, wherein the motion sensing component (110) comprises a gyroscope (114) configured to measure rotational motion data.

5) The device (100) of claim 1, wherein the motion sensing component (110) is further configured to determine, based on the current motion data, an orientation of the motion sensing component (110).

6) The device (100) of claim 5, wherein the motion sensing component (110) is further configured to adjust the current motion data for a gravity offset based on the orientation of the motion sensing component (110).

7) The device (100) of claim 6, wherein the gravity offset is determined based on a sum of squares calculation executed on the current motion data.

8) The device (100) of claim 1, wherein the motion sensing component (110) is further configured to filter, by a low-pass filter component, noise from the current motion data.

9) The device (100) of claim 1 further comprising an external switch (140) operatively coupled to the microcontroller unit (120), the external switch (140) comprising an interface button configured to actuate, when pressed, the microcontroller unit (120) to arm the motion sensing component (110), and actuate, when pressed, the microcontroller unit (120) to disarm the motion sensing component (110).

10) A theft-prevention device (100) for use in a trailer system (300), the device (100) comprising:
a) a motion sensing component (110) disposed on the trailer system (300), powered by a battery (320) of the trailer system (300) or an external battery (200), communicatively coupled to an electric braking system (310) of the trailer system (300), comprising an accelerometer (112) configured to measure linear motion data comprising current linear motion data and a gyroscope (114) configured to measure rotational motion data comprising current rotational motion data;
b) a microcontroller unit (120) communicatively coupled to the motion sensing component (110), powered by the battery (320) of the trailer system (300) or the external battery (200), comprising a processor (122) configured to execute computer-readable instructions, and a memory component (124) comprising:
i) a set of prior measurements of linear motion data and rotational motion data;
ii) computer-readable instructions for:
A) arming the motion sensing component (110) to detect the current linear motion data and the current rotational motion data;
B) receiving the current linear motion data and the current rotational motion data from the motion sensing component (110);
C) converting the current linear motion data and the current rotational motion data into a current distance measurement;
D) comparing the current distance measurement to a motion threshold based on the set of prior measurements;
E) actuating, if the current distance measurement exceeds the motion threshold, the electric braking system (310);
F) deactuating, if the current distance measurement does not exceed the motion threshold, the electric braking system (310); and
G) disarming the motion sensing component (110) to cease detecting the current linear motion data and the current rotational motion data; and
c) a charging circuit (130) operatively coupled to the battery (320) of the trailer system (300) and the external battery (200), configured to receive power from the battery (320) of the trailer system (300) to continuously charge the external battery (200);
wherein the device (100) is configured to swap between utilizing the battery (320) of the trailer system (300) and the external battery (200) as a power source depending on a comparison of a voltage of the battery (320) of the trailer system (300) to a voltage of the external battery (200).

11) The device (100) of claim 10, wherein the computer-readable instructions further comprise determining, based on the current linear motion data and the current rotational motion data, an orientation of the motion sensing component (110).

12) The device (100) of claim 11, wherein the computer-readable instructions further comprise adjusting the current linear motion data and the current rotational motion data for a gravity offset based on the orientation of the motion sensing component (110).

13) The device (100) of claim 12, wherein the gravity offset is determined based on a sum of squares calculation executed on the current linear motion data and the current rotational motion data.

14) The device (100) of claim 10, wherein the computer-readable instructions further comprise filtering, by a low-pass filter component, noise from the current distance measurement.

15) The device (100) of claim 10, wherein the computer-readable instructions further comprise adding the current linear motion data and the current rotational motion data to the set of prior measurements.

16) The device (100) of claim 10, wherein the accelerometer (112) comprises 3 axes of directional measurement capabilities.

17) A theft-prevention device (100) for use in a trailer system (300), the device (100) comprising:
a) a motion sensing component (110) disposed on the trailer system (300) powered by a battery (320) of the trailer system (300) or an external battery (200), communicatively coupled to an electric braking system (310) of the trailer system (300), comprising an accelerometer (112) configured to measure linear motion data comprising current linear motion data and a gyroscope (114) configured to measure rotational motion data comprising current rotational motion data;
b) a microcontroller unit (120) communicatively coupled to the motion sensing component (110), powered by the battery (320) of the trailer system (300) or the external battery (200), comprising a processor (122) configured to execute computer-readable instructions, and a memory component (124) comprising:
i) a set of prior measurements of linear motion data and rotational motion data;
ii) computer-readable instructions for:
A) arming the motion sensing component (110) to detect the current linear motion data and the current rotational motion data;
B) receiving the current linear motion data and the current rotational motion data from the motion sensing component (110);
C) determining, based on the current linear motion data and the current rotational motion data, an orientation of the motion sensing component (110);
D) adjusting the current linear motion data and the current rotational motion data for a gravity offset based on the orientation of the motion sensing component (110);
E) converting the current linear motion data and the current rotational motion data into a current distance measurement;
F) filtering, by a low-pass filter component, noise from the current distance measurement;
G) comparing the current distance measurement to a motion threshold based on the set of prior measurements;
H) actuating, if the current distance measurement exceeds the motion threshold, the electric braking system (310);
I) deactuating, if the current distance measurement does not exceed the motion threshold, the electric braking system (310); and
J) disarming the motion sensing component (110) to cease detecting the current linear motion data and the current rotational motion data; and
c) a charging circuit (130) operatively coupled to the battery (320) of the trailer system (300) and the external battery (200), configured to receive power from the battery (320) of the trailer system (300) to continuously charge the external battery (200);
wherein the device (100) is configured to swap between utilizing the battery (320) of the trailer system (300) and the external battery (200) as a power source depending on a comparison of a voltage of the battery (320) of the trailer system (300) to a voltage of the external battery (200).

18) The device (100) of claim 17, wherein the accelerometer (112) comprises 3 axes of directional measurement capabilities.

19) The device (100) of claim 17, wherein the gravity offset is determined based on a sum of squares calculation executed on the current linear motion data and the current rotational motion data.

20) The device (100) of claim 17, wherein the computer-readable instructions further comprise adding the current linear motion data and the current rotational motion data to the set of prior measurements.
